(19) United States
(12) Patent Application Publication
(10) Pub. No.: US 2007/0291803 A1
(43) Pub. Date: Dec. 20, 2007

(54) Active Gas Cooling for Emitter Bars

(76) Inventor: Trevor Crum, Tucson, AZ (US)

Correspondence Address: GRANT ANDERSON LLP;C/O PORTFOLIOIP, P.O. BOX 52050, MINNEAPOLIS, MN, 55402, US

(21) Appl. No.: 11/762,027

(22) Filed: Jun. 12, 2007

Related U.S. Application Data
(60) Provisional application No. 60/879,133, filed on Jan. 8, 2007.
(60) Provisional application No. 60/879,156, filed on Jan. 8, 2007.
(60) Provisional application No. 60/814,565, filed on Jun. 15, 2006.

(51) Int. Cl. H01S 3/04

(52) U.S. Cl. 372/34

(57) ABSTRACT

Methods and devices for cooling an emitter bar or stacked array of emitter bars utilizing the flow of gas through cooling channels of a heat sink housing. Some embodiments may include baffle members in the cooling channels to increase the efficiency of heat transfer from the heat sink housing to the cooling gas flowing through the cooling channels.

### RELATED APPLICATIONS

This application claims priority under 35 U.S.C. section 119(e) from U.S. Provisional Patent application Ser. No. 60/879,133 titled “Active Gas Cooling for Emitter Bars”, filed Jan. 8, 2007, by T. Crum, U.S. Provisional Patent Application Ser. No. 60/879,156 titled “Gas Cooling for Emitter Bars”, filed Jan. 8, 2007, by T. Crum and U.S. Provisional Patent Application Ser. No. 60/814,565 titled “Diode Laser System and Method of Manufacture”, filed Jun. 15, 2006, by Srinivasan, R. et al., all of which are also incorporated by reference herein in their entirety.

### BACKGROUND

Certain applications requiring laser energy may benefit from the use of light sources such as laser diodes and other light sources which are commonly available, reliable to operate and relatively cost effective as a laser energy source. Such devices may include a plurality of emitters or laser emitters in a single bar that emit laser light simultaneously in a common direction. In addition, in order to increase the output power of an emitter array, such bars of emitters may be vertically stacked in order to produce multiple rows of emitters in a single array. Stacked emitter bar arrays are useful for many different applications where high output power, compactness and reliability are required such as military, medical, industrial and the like However, each emitter bar of a stacked emitter bar array produces a significant amount of heat from energy which enters the emitter bar but which is not converted to laser light. This excess heat must be dissipated during operation of the device in order to maintain an acceptable temperature and stability of the emitter light source. Such heat dissipation becomes challenging when multiple emitter bars are stacked closely together with very little or no space between adjacent bars.

Air cooling or “passive” cooling of laser diode bars currently uses relatively large heavy pieces of heat sink material to form a primary heat sink and remove the heat with conduction. Then the user typically manages the heat removed by the primary heat sink with some other secondary heat sink mechanically attached to the laser's heat sink. Finned TEC Modules, or water cooled cold plates are typical examples of secondary heat sinks for removing heat from the primary heat sink. These secondary heat sinks are also relatively large and heavy. “Back Plane” coolers that allow the diode to be placed on the heat sink substrate and then be placed vertically to achieve a high optical output power density typically have poor thermal management and are limited by the Rth values.

Currently the industry uses micro-channel coolers designed for use with water or a similar coolant fluid and are commercially available. This is commonly referred to as “active” cooling of an emitter device. The water cooled micro-channel heat sink geometry is relatively smaller than the passive heat sink devices and allows the user to create compact vertical arrays or “stacks” of emitter bars. Because the micro-channel heat sinks are designed for use with water or some other fluid coolant, channel sizes and therefore thermal resistance properties are limited because of the pressure drop associated with the cooling fluid used at a given flow rate. The micro-channel coolers are extremely effective of low Rₜₕ values and allow the emitters to be driven at high output powers. The fluid cooling typically requires the water to be deionized and maintained within a few degrees under normal operation. The chillers, reservoir, and polishing loops are considerably large and heavy units that must be incorporated into the overall system making it difficult for portable use of the device.

Typically, such stacked arrays of emitter bars utilize elaborate and expensive cooling systems, such as fluid cooling systems which may be expensive and time consuming to produce and maintain. Such cooling systems are expensive to produce due to the design and manufacturing constraints associated with having pressurized fluids, such as water, flowing within a high power electrical device. The maintenance of such cooling systems may be expensive and time consuming due to the potential corrosive effects of water in contact with metal emitter bar materials as well as other factors. In addition, such systems require fluid pumps and fluid chilling devices in order to keep the cooling fluid cool and move the fluid through the device. These fluid pumps and chilling devices tend to large, heavy devices that add cost and complexity to a stacked emitter array device and obviate many of the advantages of the simplicity and compactness of the stacked emitter array itself.

What has been needed are methods and devices for efficiently cooling emitter bars and emitter bar arrays that are cost effective to produce and maintain. What has also been needed are methods and devices for efficiently cooling emitter bars and emitter bar arrays that are compact, light in weight and simple to operate.

### SUMMARY

Some embodiments of an actively gas cooled emitter bar assembly, include a heat sink assembly having a heat sink housing, an emitter bar mount site disposed on the heat sink housing, a cooling channel configured for gas cooling disposed within the heat sink housing adjacent the emitter bar mount site and at least one heat transfer structure disposed within the cooling channel. An emitter bar which includes at least one emitter is disposed on the emitter bar mount site of the heat sink assembly.

Some embodiments of an actively gas cooled heat sink assembly for cooling of an emitter bar, include a heat sink housing, an emitter bar mount site disposed on the heat sink housing, and a cooling channel configured for gas cooling disposed within the heat sink housing adjacent the emitter bar mount site. At least one heat transfer structure is disposed within the cooling channel.

Some embodiments of a stacked actively gas cooled emitter bar assembly, include a plurality of actively gas cooled emitter bar assemblies having a heat sink assembly with a heat sink housing, an emitter bar mount site disposed on the heat sink housing, a cooling channel configured for gas cooling disposed within the heat sink housing adjacent the emitter bar mount site and at least one heat transfer structure disposed within the cooling channel. An emitter bar which includes at least one emitter is disposed on the emitter bar mount site of the heat sink assembly. The actively gas cooled emitter bar assemblies are disposed in a stacked configuration with the cooling channels of each heat sink housing in fluid communication with each other.

Some embodiments of a method of cooling an emitter bar assembly, include providing an actively gas cooled emitter bar assembly, having a heat sink assembly with a heat sink housing, an emitter bar mount site disposed on the heat sink housing, a cooling channel configured for gas cooling disposed within the heat sink housing adjacent the emitter bar mount site and at least one heat transfer structure disposed within the cooling channel. An emitter bar which has at least one emitter is disposed on the emitter bar mount site of the heat sink assembly. Once the emitter bar assembly has been provided, cooling gas is passed through the cooling channel of the heat sink assembly.

These features of embodiments will become more apparent from the following detailed description when taken in conjunction with the accompanying exemplary drawings.

### BRIEF DESCRIPTION OF THE DRAWINGS

FIG. 1 is a perspective view of an emitter bar assembly embodiment.

FIG. 2 is a perspective view of a heat sink housing of the emitter bar assembly of FIG. 1.

FIG. 3 is an elevational view of the heat sink housing of FIG. 2.

FIG. 4 is a longitudinal cross section of an upper portion of the heat sink housing of FIG. 3 taken along lines 4-4 of FIG. 3.

FIG. 5 is a longitudinal cross section of a lower portion of the heat sink housing of FIG. 3 taken along lines 5-5 of FIG. 3.

FIG. 6 is a longitudinal cross section of the heat sink housing taken along lines 6-6 of FIG. 5.

FIG. 7 is an exploded perspective view of the heat sink housing of FIG. 3 showing a plurality of laminate elements of an embodiment of the heat sink housing.

FIG. 8 is a perspective view partially cut away of an end portion of a laminate element embodiment.

FIG. 9 is a perspective view of an embodiment of a stacked emitter bar array.

FIG. 10 is a simplified conceptual sectional view of the stacked emitter bar array of FIG. 9 taken along lines 10-10 of FIG. 9.

### DETAILED DESCRIPTION

As discussed above, there exists a need for cost effective, reliable and efficient cooling of emitter bars and stacked arrays of emitter bars. Embodiments discussed herein are directed to methods and devices for the efficiently cooling of emitter bars and emitter bar arrays with the use of actively flowing cooling gases instead of passive gas cooling or active liquid cooling. These embodiments may be in a stacked configuration and are cost effective to produce and maintain relative to the cost of production and maintenance of actively liquid cooled systems. Such embodiments may also be compact, light in weight and simple to operate relative to existing liquid cooled emitter bars or emitter bar arrays.

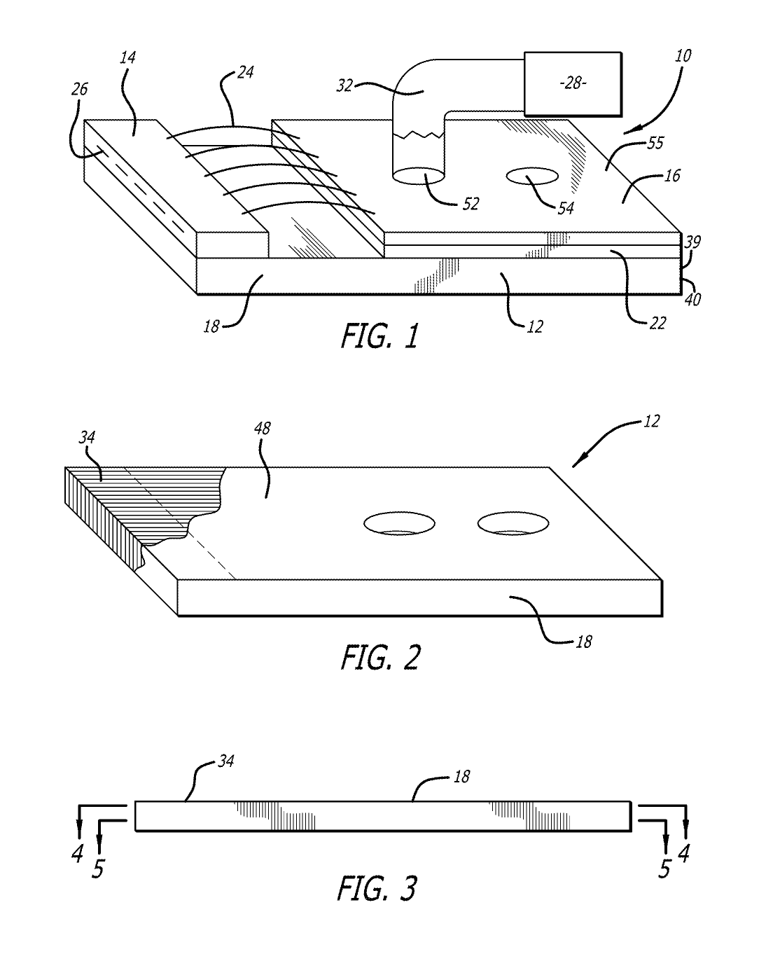

FIG. 1 shows a perspective view of an embodiment of an actively gas cooled emitter bar assembly 10 which includes a heat sink assembly 12, an emitter bar 14 secured to the heat sink assembly 12 and an electrical terminal 16 separated from a heat sink housing 18 of the heat sink assembly 12 by an insulator layer 22. The electrical terminal is electrically coupled to emitters 26 of the emitter bar 14 by conductors 24 in order to power the emitters 26 and generate light energy output. A source of pressurized gas 28 is coupled to the emitter bar assembly 10. Conduit 32 is disposed between and in fluid communication with the source of pressurized gas 28 and cooling channel of the heat sink assembly 12 of the emitter bar assembly 10.

The emitter bar embodiment 14 shown has 5 separate emitters 26, however, an emitter bar 14 having any desired number of emitters 26 may also be suitable for the assembly 10. Some embodiments of emitter bars may have about 1 emitter 26 to about 70 emitters 26, specifically, from about 5 emitters 26 to about 15 emitters 26. The emitter embodiments 26 shown are laser diodes, but may also include a wide variety of emitters configured to produce light energy from electrical energy including diodes, laser diodes, vertical cavity surface emitting lasers (VCSELs) and the like. Such emitter embodiments 26 typically have a compact structure and are capable of producing a large amount of light energy relative to their size. However, as a result of the high output power, they tend to produce a large amount of heat that must be dissipated in order to maintain the efficiency of operation. In the actively gas cooled emitter bar assembly 10 shown in FIG. 1, the heat generated by operation of the emitters 26 of the emitter bar 14 is conducted to the heat sink housing 18 of the heat sink assembly 12 and absorbed and dissipated by cooling gas flowing from the source of pressurized gas 28 through cooling channels of the heat sink housing 18.

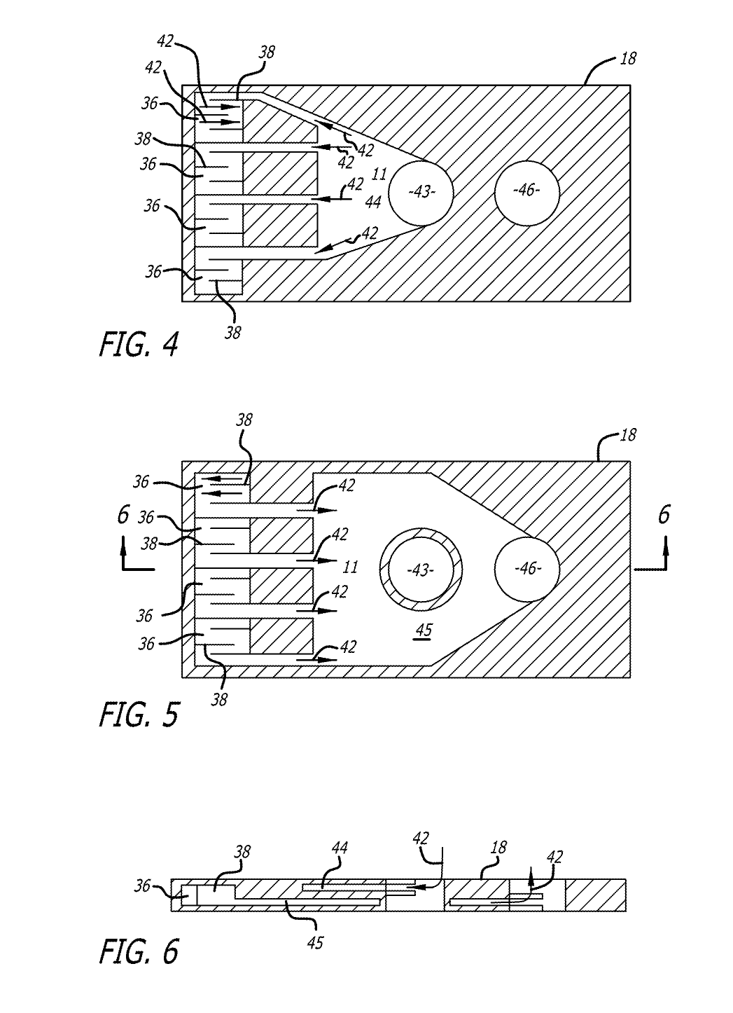

FIGS. 2-8 illustrate the heat sink assembly embodiment 12 for active gas cooling of an emitter bar 14 of the emitter bar assembly 10. The heat sink assembly 12 includes the heat sink housing 18, an emitter bar mount site 34 disposed on the heat sink housing, cooling channels 36 disposed within the heat sink housing 18 adjacent the emitter bar mount site 34 and heat transfer structures disposed within the cooling channels 36. Referring to FIGS. 4 and 5, the heat transfer structure embodiment shown includes a plurality of staggered opposed baffle members 38 disposed within the cooling channels 36 of the heat sink assembly 18. The heat sink housing 18 is divided into an upper inlet body portion 39 and a lower exhaust body portion 40. FIG. 4 illustrates the channel configuration of the inlet body portion 39 of the heat sink housing 18 and FIG. 5 illustrates the channel configuration of the exhaust body portion 40 of the heat sink housing 18. The flow of cooling gases through the body portions 39 and 40 of the heat sink housing 18 may be as indicated by arrows 42 of FIGS. 4-6. The flow may also be reversed for some embodiments and the relative position of the upper portion 39 and lower portion 40 may also be reversed for some embodiments.

The thin heat conductive baffle members or micro-fins 38 are configured to have a high surface area relative to a volume thereof in order to facilitate thermal transfer of heat energy from the baffle members 38, and thermally conductive structures adjacent thereto, to cooling gases that pass over the baffle members 38. The baffle members 38, and heat transfer structures of the cooling channel 36 generally, are made from one or more materials having a high degree of thermal conductivity. Thermally conductive metals, such as copper, gold, platinum, aluminum and the like may be used, as well as other suitable materials. The staggered opposed configuration of the baffle members 38 shown forces cooling gases passing through the cooling channels 36 to come into contact with a large surface area and allows for more efficient transfer of thermal energy from the baffle members 38 to the cooling gases. The staggered opposed configuration of the baffle members may also serve to induce some turbulence in the cooling gas flowing through the cooling channel in a zig-zag pattern so as to promote a convective effect and further increase the efficiency of thermal energy transfer.

In addition to the staggered opposed baffle members 38, other suitable heat transfer structure embodiments may also be disposed within the cooling channels 36 and used to facilitate the transfer of thermal energy from the heat sink housing 18 to cooling gases passing through the cooling channels 36. Other suitable heat transfer structures may include porous heat conductive materials, spun heat conductive materials forming thin filaments, fused micro spheres and the like. Any or all of these embodiments may also be made from thermally conductive metals, such as those discussed above.

Referring to FIGS. 4-6, an inlet manifold passage 43 of the heat sink housing 18 is in fluid communication with an inlet channel 44 that is in turn in fluid communication with the cooling channels 36 of the heat sink housing 18. Cooling gases may be emitted from the source of pressurized gas 28 and pass through conduit 32 (shown in FIG. 1) and into the inlet manifold passage 43. The cooling gas may then flow from the manifold passage 43 through the inlet channel 44 and into the cooling channels 36 of the heat sink housing 18 as shown by arrows 42. After passing through the cooling channels 36 the cooling gases exit the cooling channels 36 and enter an exhaust channel 45 of the heat sink housing 18. The cooling gases then flow to an exhaust manifold passage 46 of the heat sink housing 18.

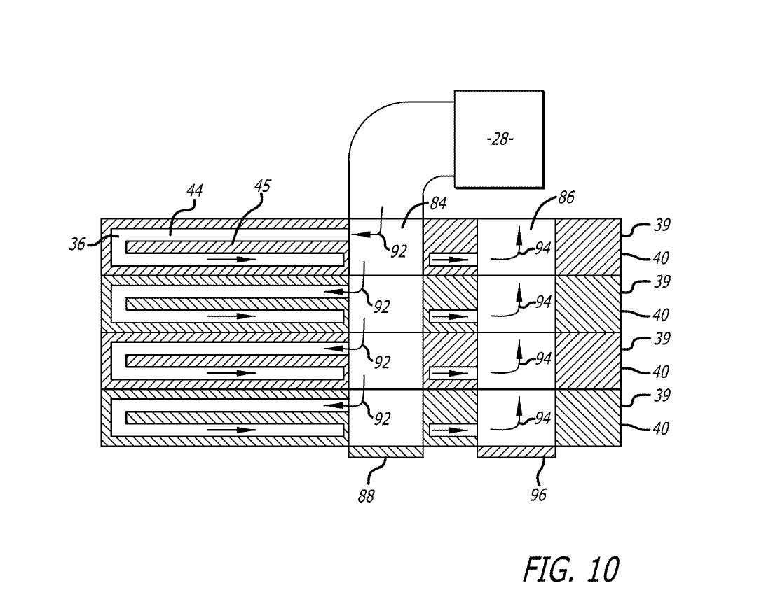

The inlet manifold passage 43 and exhaust manifold passage 46, are substantially straight walled channels having longitudinal axes that are oriented substantially perpendicular to a top surface 48 and bottom surface 50 of the heat sink housing 18. This orientation of the manifold passages allows multiple heat sink housings 18 to be disposed in a stacked configuration with the manifold passages 43 and 46 to be aligned and in fluid communication with the respective manifold passages 43 and 46 of adjacent heat sink housings 18 so as to form an inlet manifold and exhaust manifold (as shown in FIG. 10).

The electric terminal 16 and insulator 22 may also have a similar inlet manifold passage 52 and exhaust manifold passage 54, as shown in FIG. 1, that are configured to align with the inlet and exhaust manifold passages 43 and 46 of the heat sink housing 18 so as to form a continuous exhaust manifold and inlet manifold in fluid communication with the respective exhaust and inlet channels 44 and 45 of the cooling channel system. The manifold passages 43 and 46 of the lowest heat sink housing 18 or the heat sink housing 18 disposed opposite the input of the conduit 32 in a stacked configuration of heat sink housing 18 may need to be sealed so as to form a fluid tight space to prevent leakage of cooling gas that would otherwise be directed into the input channel or channels 44 or cooling channel system generally. In a system 10 having a single emitter bar 14 and heat sink housing 18, the bottom of the inlet passage manifold adjacent the bottom surface 50 of the heat sink housing 18 may need to be sealed. This arrangement applies in embodiments, such as the emitter bar assembly 10 shown in FIG. 1, wherein the conduit 32 providing the cooling gas is coupled to the inlet manifold passages 43 and 52 at a top surface 55 of the electrical terminal 16.

The source of pressurized gas 28 may incorporate a variety of devices or mechanisms to move cooling gases, including but not limited to gas pumps, gas fans, pressurized vessels and the like. The source of pressurized gas may also include an optional chilling device (not shown) that serves to cool cooling gas or gases to a temperature that is below the ambient temperature of the environment adjacent the source of pressurized gas 28. Chilling devices such as vortex tubes as well as other techniques may be used to chill the cooling gas prior to passing the cooling gas through the cooling channels. Vortex tubes may be used to chill the gas supply up to about 45 degrees Celsius for some embodiments. Vortex tubes may also be rated for use with various input pressures. The source of pressurized gas may produce an output pressure of about 20 psi to about 1000 psi. The source of pressurized gas and transverse cross sectional area of the cooling channels 36 and cooling channel system generally which includes the cooling channels 36, inlet channel 44, and exhaust channel 45, may be configured to produce a flow of cooling gas through the cooling channel of about 10 scfm to about 200 scfm, more specifically, about 10 scfm to about 100 scfm. The temperature of the cooling gas used may be about room temperature or about 22 degrees Celsius to about 26 degrees Celsius. The temperature may also be chilled to a lower temperature such as about 10 degrees Celsius to about 20 degrees Celsius.

The embodiment of the assembly 10 discussed above includes a source of pressurized gas 28 that generates positive gas pressure as the mechanism by which cooling gas is moved through the cooling channels 36 of the assembly 10. However, the source of pressurized gas 28 may include a variety of other suitable devices and methods to move cooling gas through the cooling channels 36. For example, cooling gases may be “pulled” through the cooling channels 36 by use of a source of pressurized gas 28 that is configured to generate negative pressure such as a vacuum pump, venturi jet or the like which is in fluid communication with the exhaust channels 45 of the heat sink housing 18. The flow of cooling gas may also be readily reversed through the cooling channels 36 with the exhaust channel 45 serving as inlet channels and the inlet channel 44 serving as an exhaust channel.

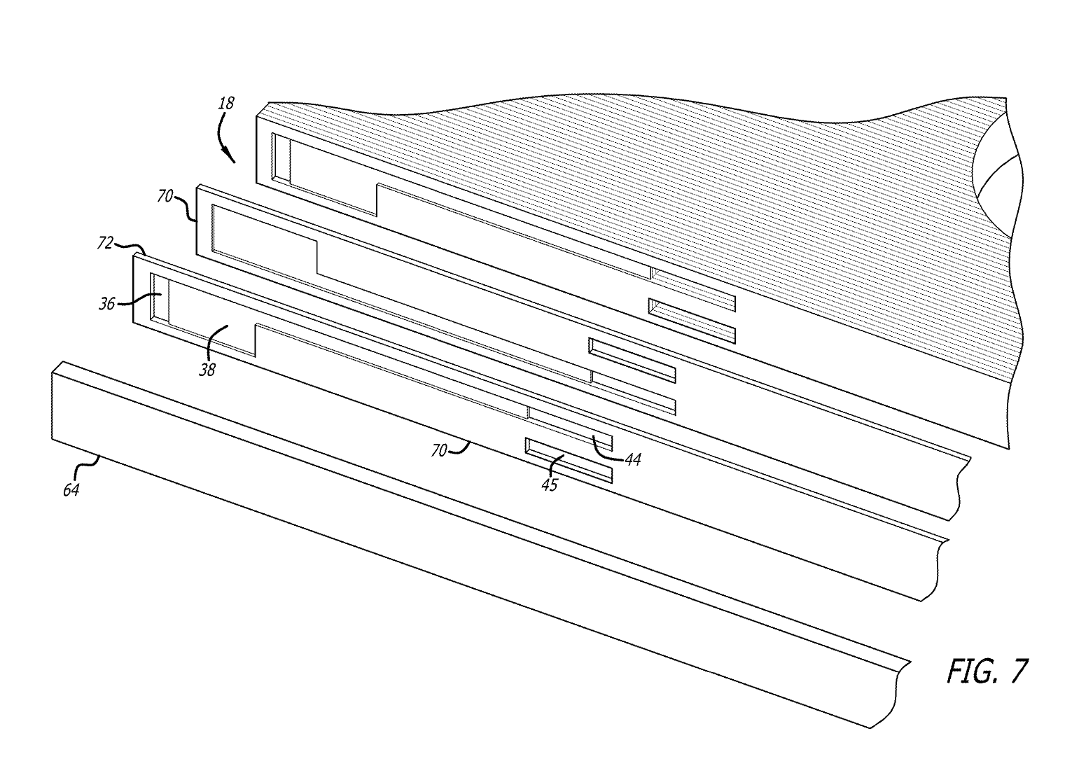

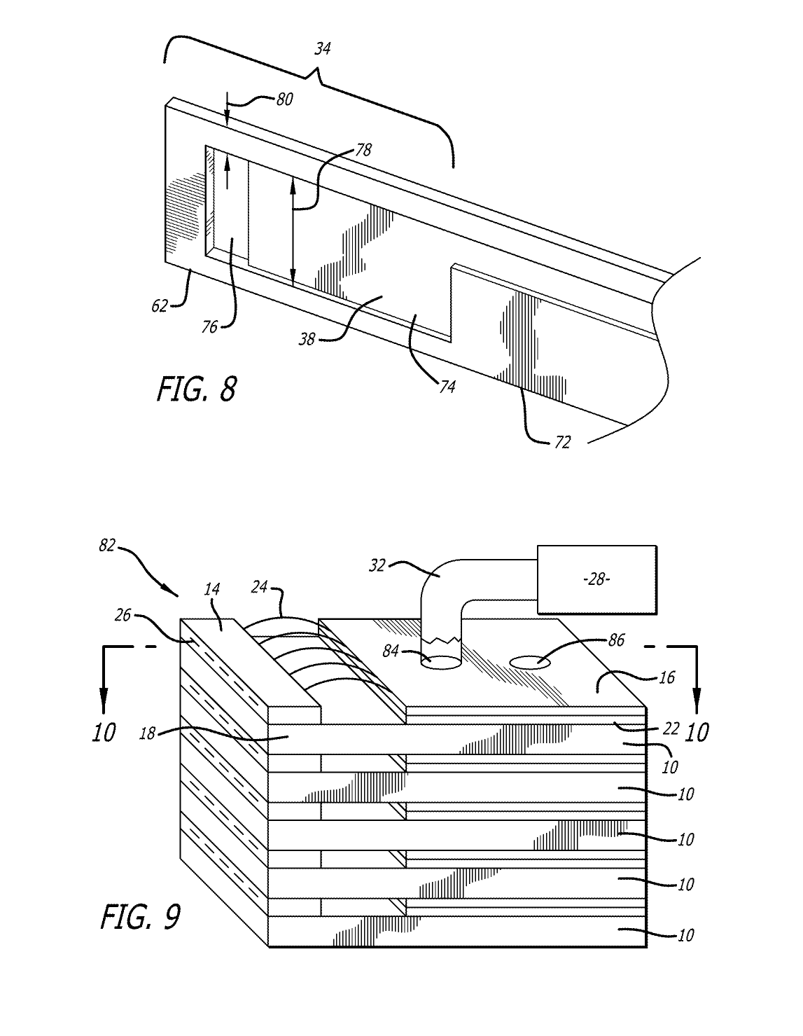

The heat sink housing 18 may be constructed by any suitable method, however, the heat sink housing embodiment 18 shown is made by a laminated technique wherein a large number of thin elongate laminate elements 62 preconfigured to provide a desired structure are laminated together. FIGS. 7 and 8 show this structure in more detail wherein the elongate thin laminate elements 62, which are substantially rectangular in shape, are fused or otherwise secured together to produce the monolithic structure of the heat sink housing 18. Several solid laminate elements 64 are shown in FIG. 7 having no voids disposed along a length thereof. Solid laminate elements 64 are configured to be disposed adjacent the laminate elements 70 so as to provide a wall portion of the channel formed by the voids of laminate elements 70.

Laminate elements 70 include an end portion 72 which is configured to produce the cooling channels 36 and the opposed staggered baffles 38 within the cooling channel 36, as shown in more detail in FIG. 8. The inlet channel 44 and exhaust channel 45 are also formed by voids in elements 70. The baffle members 38 are thinner in section than the respective laminate element 62 which allows for a recessed portion 74 adjacent the baffle member 38 which constitutes a portion of the cooling channel 36 when the laminate elements 62 are in a laminated configuration. A void 76 adjacent the baffle member 38 passes entirely through the laminate element 70 so as to form another portion of the cooling channel 36. A transverse dimension and height of the cooling channel 36 adjacent the emitter mount site 34 is indicated by arrow 78. The thickness of the heat sink body 18 or wall section of the cooling channel 36 formed by voids 76 is indicated by arrow 80. In some embodiments of the heat sink housing 18, it may be desirable to have the thickness 80 of the wall section of the cooling channel 36 be less than a transverse dimension 78 of the cooling channel 36 at the same position so as to allow the heat generated by the emitter bar 14 mounted to the emitter bar mount site 34 to be readily transferred to the cooling gas flowing through the cooling channels 36. The same relation may also be applied to the relative cross sectional areas of the cooling channel 36 and adjacent wall section disposed between the cooling channels 36 and emitter bar mount site 34. For some embodiments, the cross sectional area of the cooling channel may be about 0.005 mm² to about 10 mm², more specifically, about 0.001 mm² to about 0.1 mm². Channel thicknesses of up to about 25 microns or less may be generated by partial etching of metal sheets for some embodiments. For some embodiments, the thickness of the wall section disposed between the cooling channel and emitter bar mount site 34 may be about 0.5 mm to about 10 mm, more specifically, about 1 mm to about 5 mm. Some embodiments of the heat sink housing 18 may have a length of about 10 mm to about 100 mm, a width of about 5 mm to about 50 mm, and a thickness of about 1 mm to about 10 mm.

In some embodiments, the laminate elements 62 are made of copper and/or copper alloys and may be secured or otherwise laminated together by a heat fusion process. In some heat fusion methods, copper oxide may be allowed to form on outside surfaces of adjacent laminate elements 62. The laminate elements are then pressed together and heated. Because the copper oxide layer on the exterior surface of the adjacent laminate elements 62 has a lower melting point than the more pure copper of the laminate element, the copper oxide may be heated to its melting point without melting the more pure copper substrate. Once the copper oxide outer layer has been heated to the melting point and the copper oxide layers of adjacent laminate elements 62 allowed to flow together, the laminate elements 62 are allowed to cool and the copper oxide solidifies and secures adjacent laminate elements 62 together. The heat sink body 18 may also be molded or machined from one or more pieces of thermally conductive material. Some embodiments of the laminate elements may have a length of about 10 mm to about 100 mm, a height of about 1 mm to about 10 mm, and a thickness of about 0.02 mm to about 0.5 mm. Some baffle member embodiments 38 formed from the laminate elements may have a thickness of about 0.01 mm to about 1 mm.

Some embodiments of actively gas cooled emitter bar assemblies 10 may be disposed in a stacked array configuration. FIGS. 9 and 10 illustrate a stacked array 82 of actively gas cooled emitter bar assemblies 10, including a plurality of actively gas cooled emitter bar assemblies 10 each having a heat sink assembly 12 with a heat sink housing 18, an emitter bar mount site 34 disposed on the heat sink housing 18, a cooling channel 36 disposed within the heat sink housing 18 adjacent the emitter bar mount site 34 and heat transfer structures disposed within the cooling channels 36, as discussed above. An emitter bar 14 which includes 5 emitters 26 is disposed on the emitter bar mount site 34 of each heat sink assembly 18. FIG. 10 is a simplified conceptual sectional view of the stacked array 82 shown without the emitter bars 14, terminals 16 or insulation layer 22 in order to illustrate an embodiment of the flow of cooling gas through the stacked array 82.

Each inlet manifold passage 43 and 52 and exhaust manifold passage 46 and 54, respectively, of the heat sink housings 18 are substantially aligned so as to form a continuous inlet manifold 84 and a continuous exhaust manifold 86. The inlet manifold 84 communicates directly with the respective inlet channels 44 of the heat sink housings 18 and the exhaust manifold 86 communicates directly with the respective exhaust channels 45 of the heat sink housings 18. The inlet manifold 84 is also in fluid communication with conduit 32 which is in fluid communication with the source of pressurized gas 28. A bottom end or end opposite the conduit 32 of the inlet manifold 84 is sealed with a sealing member 88 to make the inlet manifold 84 fluid tight and cause cooling gas emitted from the source of pressurized gas 28 to flow through the conduit 32, into the inlet manifold 84 and then into each respective inlet channels 44 of each inlet body portion 39 of each heat sink housing 18 of the stacked array 82, as indicated by arrows 92 in FIG. 10. The cooling gas then flows through the cooling channel system including the inlet channels 44, cooling channels 36 and exhaust channels 45, exiting the cooling channel system through the exhaust manifold 86, as indicated by arrows 94. The exhaust manifold is sealed at an end with a sealing member 96.

The stacked array 82 is shown having 5 emitter bar assemblies 10 disposed in a stacked configuration, however, any suitable number of emitter bar assemblies 10 may be included in a stacked array 82, provided that sufficient gas pressure can be maintained along each input channel 44 to provide sufficient cooling gas flow and heat transfer for efficient and effective cooling of each emitter bars 14 by each of the respective heat sink assemblies 12. Inlet manifold passage 43 and exhaust manifold passage 46 of appropriate transverse cross section may be useful in maintaining suitable cooling gas pressure and cooling gas flow through the cooling channels 36 of each emitter bar assembly 10. Inlet manifold passage 43 of some embodiments may have a transverse cross sectional area of about 5 mm² to about 20 mm².

With regard to the above detailed description, like reference numerals used therein refer to like elements that may have the same or similar dimensions, materials and configurations. While particular forms of embodiments have been illustrated and described, it will be apparent that various modifications can be made without departing from the spirit and scope of the embodiments of the invention. Accordingly, it is not intended that the invention be limited by the forgoing detailed description.

What is claimed is:

1. An actively gas cooled emitter bar assembly, comprising:
a heat sink assembly including a heat sink housing, an emitter bar mount site disposed on the heat sink housing, a cooling channel configured for gas cooling disposed within the heat sink housing adjacent the emitter bar mount site and at least one heat transfer structure disposed within the cooling channel; and
an emitter bar which includes at least one emitter and which is disposed on the emitter bar mount site of the heat sink assembly.

2. The emitter bar assembly of claim 1 further comprising a source of pressurized gas in fluid communication with the cooling channel.

3. The emitter bar assembly of claim 2 wherein the source of pressurized gas is configured to produce pressurized gas at a pressure of about 20 psi to about 1000 psi.

4. The emitter assembly of claim 2 wherein a resistance to flow of the cooling channel and pressure from the source of pressurized gas are configured to produce a gas flow through the cooling channel of about 10 scfm to about 100 scfm.

5. The emitter bar assembly of claim 1 wherein heat transfer structure comprises a thermally conductive material having a high surface area relative to volume to facilitate heat exchange between the heat sink body and cooling gas passing through the cooling channel.

6. The emitter bar assembly of claim 5 wherein the heat transfer structure comprises at least one thin heat conductive baffle member.

7. The emitter bar assembly of claim 6 wherein the heat transfer structure comprises a plurality of staggered opposed conductive baffle members to facilitate heat exchange between the heat sink body and cooling gas passing through the cooling channel.

8. The emitter bar assembly of claim 1 wherein heat transfer structure comprises porous material.

9. The emitter bar assembly of claim 8 wherein porous material comprises metallic wool.

10. The emitter bar assembly of claim 8 wherein porous material comprises fused metallic micro spheres.

11. The emitter bar assembly of claim 1 wherein the heat sink housing of the heat sink assembly comprises of a heat conductive metal.

12. The emitter bar assembly of claim 11 wherein the heat conductive metal comprises copper.

13. The emitter bar assembly of claim 1 wherein a wall thickness of the heat sink housing disposed between the cooling channel and the emitter mount site is thinner than the cooling channel.

14. The emitter bar assembly of claim 1 wherein a wall thickness of the heat sink housing disposed between the cooling channel and the emitter mount site is about 0.5 mm to about 10 mm.

15. The emitter bar assembly of claim 1 wherein a volume of a segment of the cooling channel is greater than a volume of a corresponding segment of a wall portion of the heat sink housing adjacent the cooling channel disposed between the cooling channel and the emitter mount site.

16. The emitter bar assembly of claim 1 wherein the emitter bar comprises a plurality of emitters.

17. The emitter bar assembly of claim 1 further comprising inlet and outlet channels in fluid communication with the cooling channel.

18. The emitter bar assembly of claim 1 wherein the at least one emitter comprises a laser diode.

19. An actively gas cooled heat sink assembly for cooling of an emitter bar, comprising a heat sink housing, an emitter bar mount site disposed on the heat sink housing, a cooling channel configured for gas cooling disposed within the heat sink housing adjacent the emitter bar mount site and at least one heat transfer structure disposed within the cooling channel.

20. The heat sink assembly of claim 19 further comprising a source of pressurized gas in fluid communication with the cooling channel.

21. The heat sink assembly of claim 20 wherein the source of pressurized gas is configured to produce pressurized gas at a pressure of about 20 psi to about 1000 psi.

22. The heat sink assembly of claim 20 wherein a resistance to flow of the cooling channel and pressure from the source of pressurized gas are configured to produce a gas flow of about 10 scfm to about 100 scfm.

23. The emitter bar assembly of claim 19 wherein heat transfer structure comprises a thermally conductive material having a high surface area relative to volume to facilitate heat exchange between the heat sink body and cooling gas passing through the cooling channel.

24. The emitter bar assembly of claim 23 wherein the heat transfer structure comprises at least one thin heat conductive baffle member.

25. The emitter bar assembly of claim 24 wherein the heat transfer structure comprises a plurality of staggered opposed conductive baffle members to facilitate heat exchange between the heat sink body and cooling gas passing through the cooling channel.

26. The heat sink assembly of claim 19 wherein heat transfer structure comprises porous material.

27. The heat sink assembly of claim 19 wherein porous material comprises metallic wool.

28. The heat sink assembly of claim 19 wherein porous material comprises fused metallic micro spheres.

29. The heat sink assembly of claim 19 wherein the heat sink housing comprises of a heat conductive metal.

30. The heat sink assembly of claim 29 wherein the heat conductive metal comprises copper.

31. The heat sink assembly of claim 19 wherein a wall thickness of the heat sink housing disposed between the cooling channel and the emitter mount site is thinner than the cooling channel.

32. The emitter bar assembly of claim 19 wherein a wall thickness of the heat sink housing disposed between the cooling channel and the emitter mount site is about 0.5 mm to about 10 mm.

33. The heat sink assembly of claim 19 wherein a volume of a segment of the cooling channel is greater than a volume of a corresponding segment of a wall portion of the heat sink housing adjacent the cooling channel disposed between the cooling channel and the emitter mount site.

34. The heat sink assembly of claim 19 further comprising inlet and outlet conduits in fluid communication with the cooling channel.

35. A stacked actively gas cooled emitter bar assembly, comprising a plurality of actively gas cooled emitter bar assemblies including a heat sink assembly having a heat sink housing, an emitter bar mount site disposed on the heat sink housing, a cooling channel configured for gas cooling disposed within the heat sink housing adjacent the emitter bar mount site, at least one heat transfer structure disposed within the cooling channel, and an emitter bar which includes at least one emitter and which is disposed on the emitter bar mount site of the heat sink assembly with the actively gas cooled emitter bar assemblies disposed in a stacked configuration with the cooling channels of each heat sink housing in fluid communication with each other.

36. The stacked emitter bar assembly of claim 35 further comprising a source of pressurized gas in fluid communication with the cooling channels of the heat sink assemblies.

37. The stacked bar assembly of claim 35 wherein a plurality of heat sink housings comprise a manifold passage in fluid communication with the a respective cooling channel and wherein the manifold passages are configured so as to be aligned and form a manifold.

38. The stacked emitter bar assembly of claim 37 further comprising a source of pressurized gas in fluid communication with the manifold.

39. The stacked emitter bar assembly of claim 37 wherein a plurality of heat sink housings comprise an inlet manifold passage in fluid communication with an inlet end of a respective cooling channel and an exhaust manifold passage in fluid communication with an exhaust end of a respective cooling channel wherein the respective manifold passages are configured so as to be aligned and form an inlet manifold and an exhaust manifold.

40. The stacked emitter bar assembly of claim 39 further comprising a source of pressurized gas in fluid communication with the inlet manifold.

41. The stacked emitter bar assembly of claim 40 wherein the source of pressurized gas further comprises a chilling device configured to cool cooling gas below an ambient temperature.

42. The stacked emitter bar assembly of claim 41 wherein the chilling device comprises a vortex tube.

43. A method of cooling an emitter bar assembly, comprising:
providing an actively gas cooled emitter bar assembly, including
a heat sink assembly having a heat sink housing, an emitter bar mount site disposed on the heat sink housing, a cooling channel configured for gas cooling disposed within the heat sink housing adjacent the emitter bar mount site and at least one heat transfer structure disposed within the cooling channel; and
an emitter bar which has at least one emitter and which is disposed on the emitter bar mount site of the heat sink assembly; and
activating the at least one emitter and passing cooling gas through the cooling channel of the heat sink assembly.

44. The method of claim 43 further comprising providing a source of pressurized gas in fluid communication with the cooling channel and wherein passing cooling gas through the cooling channel of the heat sink assembly comprises forcing cooling gas through the cooling channel from the source of pressurized gas.

45. The method of claim 43 further comprising actively cooling the cooling gas prior to passing the cooling gas through the cooling channel.

46. The method of claim 45 wherein actively cooling the cooling gas prior to passing the cooling gas through the cooling channel comprises actively cooling the cooling gas using a vortex tube.
